(19) United States
(12) Patent Application Publication
(10) Pub. No.: US 2004/0069278 A1
(43) Pub. Date: Apr. 15, 2004

(54) Fuel injection device

(76) Inventors: Kenji Okamoto, Higashi-Matsuyama (JP); Akira Kunishima, Higashi-Matsuyama (JP)

Correspondence Address: WENDEROTH, LIND & PONACK, L.L.P., 2033 K STREET N. W., SUITE 800, WASHINGTON, DC, 20006-1021, US

(21) Appl. No.: 10/677,268

(22) Filed: Oct. 3, 2003

Related U.S. Application Data
(63) Continuation of application No. PCT/JP02/04504, filed on May 9, 2002.

(51) Int. Cl. F02M 1/00

(52) U.S. Cl. 123/458; 123/456

(57) ABSTRACT

In a state in which a high-pressure control solenoid valve is driven to control the pressure in a common rail (refer to Step S100), when the pressure in the common rail exceeds a predetermined value (refer to Step S104), a driving current determined by a prescribed value map that defines the correlation between the pressure in the common rail and the driving current of the high-pressure control solenoid valve is corrected based on an actual pressure in the common rail and the driving current of the high-pressure control solenoid valve at the actual pressure (refer to Steps S106, 108, S110, 112), and the corrected driving current is passed to the high-pressure control solenoid valve, thereby ensuring appropriate and stable injection control even when there exists a variation in operational characteristics among pressure control valves.

### FIELD OF THE INVENTION

The present invention relates to an operation control method in a fuel injection device that injects and supplies a fuel to an internal combustion engine, and to the fuel injection device, more particularly to those in which enhancement in control stability and so on are realized.

### DESCRIPTION OF THE RELATED ART

In recent years, as one type of a fuel injection device that injects and supplies a fuel to an internal combustion machine such as an engine, proposed are various fuel injection devices called common-rail fuel injection devices that are so configured that a high-pressure fuel is temporarily stored in a fuel passage called a common rail, and thereafter, a plurality of injection nozzles connected to this common rail, each having a solenoid valve, are controlled, thereby enabling concurrent injection, and they are now well known in the art (for example, refer to Japanese Patent Laid-open No. Hei 10-54318).

In such a common-rail fuel injection device, whether or not an injection characteristic is good greatly depends on stability and reliability in controlling the pressure in the common rail, namely, the common-rail pressure, at a target pressure. This common-rail pressure control is roughly classified, in terms of the positions where the control is performed, into a high-pressure side control, in which pressure control is performed on a high-pressure side, in other words, on a downstream side of a high-pressure pump for pressure-sending a fuel to the common rail so as to cause the common rail pressure to be a desired pressure, and a low-pressure control, in which common-rail pressure control is performed on an upstream side of the high-pressure pump, and each has its own merit and demerit, and though various control methods and control devices have been conventionally proposed in which the respective merits and demerits thereof are taken into consideration, they cannot still be said to be satisfactory.

Further, the conventional fuel injection devices are so configured that various controls are performed on the assumption that operational characteristics such as a valve opening characteristic of a pressure control valve having a solenoid valve equal to presumed ones, but in practice, however, there sometimes occur variations among individual pressure control valves, and it is desired that originally targeted stable and reliable injection control should be performed even when there are such variations in the characteristics.

### SUMMARY OF THE INVENTION

The present invention is made from the above viewpoint, and an object thereof is to provide an operation control method in a fuel injection device and the fuel injection device that enable appropriate control of the common-rail pressure in accordance with various operation states of the fuel injection device.

Another object of the present invention is to provide an operation control method in a fuel injection device and the fuel injection device that enable the execution of originally targeted injection control even if there are variations in operational characteristics among pressure control valves.

According to a form of a first invention, provided is an operation control method in a fuel injection device including: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,

the method being so configured that, when a pressure in the common rail exceeds a predetermined value in a state in which the high-pressure control solenoid valve is driven to control the pressure in the common rail, a driving current determined by a prescribed value map defining a correlation between the pressure in the common rail and the driving current of the high-pressure control solenoid valve is corrected based on an actual pressure in the common rail and a driving current of the high-pressure control solenoid valve at the actual pressure, and the corrected driving current is passed to the high-pressure control solenoid valve.

With such a configuration, the driving current of the high-pressure control solenoid valve that is determined by the prescribed value map is corrected according to an actual driving state under a predetermined condition, so that it is possible to realize appropriate and reliable fuel injection in response to variations in operational characteristics among high-pressure control solenoid valves and difference in operational conditions among individual devices.

According to a form of a second invention, provided is an operation control method in a fuel injection device including: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,

the method being so configured that, when an engine is in a predetermined start-up state, the high-pressure control solenoid valve is controlled to be driven until a predetermined period of time passes after the engine is activated, thereby controlling a pressure in the common rail.

In such an operation control method, when the engine is in the start-up state, the high-pressure control solenoid valve is driven in a manner appropriate for causing the common-rail pressure to quickly fall within a stable range, so that stable and reliable fuel injection control can be realized.

According to a form of a third invention, provided is an operation control method in a fuel injection device including: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,

the method being so configured that, when an absolute value of a variation amount of a pressure in the common rail exceeds a predetermined value, the high-pressure control solenoid valve is controlled to be driven, thereby controlling the pressure in the common rail.

According to a form of a fourth invention, provided is an operation control method in a fuel injection device including: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provide in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve, the method being so configured that, when a fluctuation of a driving torque of the high-pressure pump exceeds a predetermined state, the high-pressure control solenoid valve is controlled to be driven, thereby controlling a pressure in the common rail.

According to a form of a fifth invention, provided is an operation control method in a fuel injection device including: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,

the method being so configured that, when an average driving torque of the high-pressure pump exceeds a predetermined state, the low-pressure control solenoid valve is controlled to be driven, thereby controlling a pressure in the common rail.

According to a form of a sixth invention, provided is an operation control method in a fuel injection device including: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,

the method being so configured that, when a fuel temperature is in a predetermined high-temperature state and the high-pressure control solenoid valve is being driven, the low-pressure control solenoid valve is controlled to be driven in place of driving the high-pressure control solenoid valve, until the fuel temperature falls within a predetermined reference temperature range, thereby controlling a pressure in the common rail, whereas,

when the fuel temperature is in a predetermined low-temperature state and the low-pressure control solenoid valve is being driven, the high-pressure control solenoid valve is controlled to be driven in place of driving the low-pressure control solenoid valve, until the fuel temperature falls within the predetermined reference temperature range, thereby controlling the pressure in the common rail.

According to a form of a seventh invention, provided is an operation control method in a fuel injection device including: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,

the method being so configured that, when the fuel injection device is in a predetermined unstable operation state, the high-pressure control solenoid valve is controlled to be driven, thereby controlling a pressure in the common rail.

According to a form of an eighth invention, provided is a fuel injection device includes: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,

the control unit being so configured to control the low-pressure control solenoid valve and the high-pressure control solenoid valve to be selectively driven based on a temperature of the fuel, a pressure in the common rail, an engine rotation speed, an accelerator depression amount, and position information of an ignition engine key that are inputted from an external part, and having a prescribed value map stored therein that defines correlation between the pressure in the common rail and a driving current of the high-pressure control solenoid valve, and

in controlling the high-pressure control solenoid valve to be driven, the control unit determines the driving current of the high-pressure control solenoid valve for a desired pressure in the common rail based on the prescribed value map and passes the determined driving current to the high-pressure control solenoid valve until the pressure in the common rail is judged to exceed a predetermined variation amount, whereas,

when the pressure in the common rail is judged to exceed a predetermined value, the control unit corrects the driving current determined by the prescribed value map based on an actual pressure in the common rail and the driving current of the high-pressure control solenoid valve at the actual pressure, and passes the corrected driving current to the high-pressure control solenoid valve.

According to a form of a ninth invention, provided is a fuel injection device including: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,

the control unit being so configured to control the low-pressure control solenoid valve and the high-pressure control solenoid valve to be selectively driven based on a temperature of the fuel, a pressure in the common rail, an engine rotation speed, an accelerator depression amount, and position information of an ignition engine key that are inputted from an external part, and

as a result of judgment on whether or not an engine is in a predetermined start-up state,

when the engine is judged to be in the predetermined start-up state, the control unit controls the high-pressure control solenoid valve to be driven until a predetermined period of time passes after the engine is activated, whereas,

when the engine is judged not to be in the predetermined start-up state, the control unit drives the low-pressure control solenoid valve.

According to a form of a tenth invention, provided is a fuel injection device including: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,

the control unit being so configured to control the low-pressure control solenoid valve and the high-pressure control solenoid valve to be selectively driven based on a temperature of the fuel, a pressure in the common rail, an engine rotation speed, an accelerator depression amount, and position information of an ignition engine key that are inputted from an external part, and

as a result of judgment on whether or not an absolute value of a variation amount of the pressure in the common rail exceeds a predetermined value,

when the absolute value of the variation amount of the pressure in the common rail is judged to exceed the predetermined value, the control unit controls the high-pressure control solenoid valve to be driven, whereas,

when the absolute value of the variation amount of the pressure in the common rail is judged not to exceed the predetermined value, the control unit controls the low-pressure control solenoid valve to be driven.

According to a form of an eleventh invention, provided is a fuel injection device including: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,

the control unit being so configured to control the low-pressure control solenoid valve and the high-pressure control solenoid valve to be selectively driven based on a temperature of the fuel, a pressure in the common rail, an engine rotation speed, an accelerator depression amount, and position information of an ignition engine key that are inputted from an external part, and

as a result of judgment on whether or not a fluctuation of a driving-torque of the high-pressure pump exceeds a predetermined state,

when the fluctuation of the driving torque of the high-pressure pump is judged to exceed the predetermined state, the control unit controls the high-pressure control solenoid valve to be driven, whereas,

when the fluctuation of the driving torque of the high-pressure pump is judged not to exceed the predetermined state, the control unit controls the low-pressure control solenoid valve to be driven.

According to a form of a twelfth invention, provided is a fuel injection device including: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,

the control unit being so configured to control the low-pressure control solenoid valve and the high-pressure control solenoid valve to be selectively driven based on a temperature of the fuel, a pressure in the common rail, an engine rotation speed, an accelerator depression amount, and position information of an ignition engine key that are inputted from an external part, and

as a result of judgment on whether or not an average driving torque of the high-pressure pump exceeds a predetermined state,

when the average driving torque of the high-pressure pump is judged to exceed the predetermined state, the control unit controls the low-pressure control solenoid valve to be driven, whereas,

when the average driving torque of the high-pressure pump is judged not to exceed the predetermined state, the control unit controls the high-pressure control solenoid valve to be driven.

According to a form of a thirteenth invention, provided is a fuel injection device including: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,

the control unit being so configured to control the low-pressure control solenoid valve and the high-pressure control solenoid valve to be selectively driven based on a temperature of the fuel, a pressure in the common rail, an engine rotation speed, an accelerator depression amount, and position information of an ignition engine key that are inputted from an external part, and

as a result of judgment on whether or not a temperature of the fuel is in a predetermined high temperature state,

when the temperature of the fuel is judged to be in the predetermined high temperature state, the control unit judges whether or not the high-pressure control solenoid valve is being driven, and when the high-pressure control solenoid valve is judged to be being driven, the control unit controls the low-pressure control solenoid valve to be driven in place of driving the high-pressure control solenoid valve, until the temperature of the fuel falls within a predetermined reference temperature range, while, when the high-pressure control solenoid valve is judged not to be being driven, the control unit controls the low-pressure control solenoid valve to be driven until the temperature of the fuel falls within the predetermined reference temperature range, whereas,

when the temperature of the fuel is judged not to be in the predetermined high temperature state, the control unit judges whether or not the temperature of the fuel is in a predetermined low temperature state, and when the temperature of the fuel is judged to be in the predetermined low temperature state, the control unit judges whether or not the low-pressure control solenoid valve is being driven, and when the low-pressure control solenoid valve is judged to be in the driven state, the control unit controls the high-pressure control solenoid valve to be driven in place of driving the low-pressure control solenoid valve until the temperature of the fuel falls within the predetermined reference temperature range, while, when the low-pressure control solenoid valve is judged not to be in the driven state, the control unit controls the high-pressure control solenoid valve to be driven until the temperature of the fuel falls within the predetermined reference temperature range.

According to a form of a fourteenth invention, provided is a fuel injection device including: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,

the control unit being so configured to control the low-pressure control solenoid valve and the high-pressure control solenoid valve to be selectively driven based on a temperature of the fuel, a pressure in the common rail, an engine rotation speed, an accelerator depression amount, and position information of an ignition engine key that are inputted from an external part, and

as a result of judgment on whether or not a state of fuel injection control is a predetermined unstable operation state,

when the state of the fuel injection control is judged to be the predetermined unstable operation state, the control unit controls the high-pressure control solenoid valve to be driven, whereas,

when the state of the fuel injection control is judged not to be the predetermined unstable operation state, the control unit controls the low-pressure control solenoid valve to be driven.

### BRIEF DESCRIPTION OF THE DRAWINGS

FIG. 1 is a block diagram showing a configuration example of a common-rail fuel injection device according to an embodiment of the present invention;

FIG. 2 is a flowchart showing the procedure of learning-based control executed in a control unit in the common-rail fuel injection device shown in FIG. 1;

FIG. 3 is a flowchart showing the procedure of a driving current correction process in the flowchart shown in FIG. 2;

FIG. 4 is an explanatory chart explaining the procedure of deriving a driving current A₀ corresponding to an actually measured common rail pressure, using a prescribed value map showing the correlation between common rail pressure and driving current of a high-pressure control solenoid valve;

FIG. 5 is an explanatory chart explaining the procedure of deriving a driving current B₀ corresponding to a target common rail pressure, using the prescribed value map showing the correlation between common rail pressure and driving current of the high-pressure control solenoid valve;

FIG. 6 is a flowchart showing the overall procedure of switching control between a low-pressure control solenoid valve and a high-pressure control solenoid valve, which is executed in the control unit in the common rail injection device shown in FIG. 1;

FIG. 7 is a flowchart showing the procedure of a control process for start-up time;

FIG. 8 is a flowchart showing the procedure of a control process for transient response state;

FIG. 9 is a flowchart showing the procedure of a control process for driving torque fluctuation;

FIG. 10 is a flowchart showing the procedure of a control process for high average driving torque;

FIG. 11 is a flowchart showing the procedure of the fuel-temp.-based control process; and

FIG. 12 is a flowchart showing the procedure of a control process for unstable operation.

### DETAILED DESCRIPTION OF THE PREFERRED EMBODIMENTS

For more detailed explanation of the present invention, the explanation thereof will be given, following the attached drawings.

It is to be understood that the members, arrangement, and so on explained below are not to limit the present invention, and various changes and modifications can be made within the sprit and scope of the present invention.

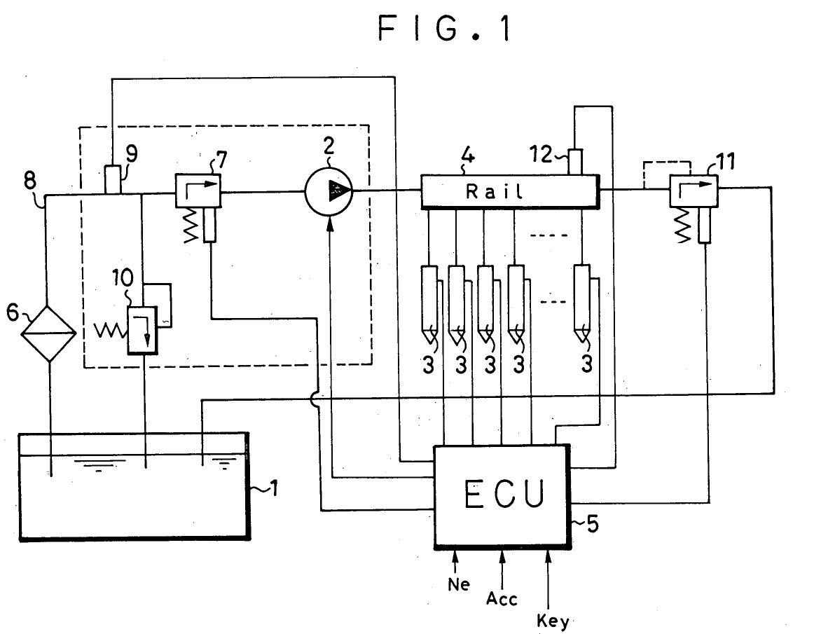

First, the configuration of a common-rail fuel injection device according to an embodiment of the present invention (hereinafter, referred to as “this device”) will be explained with reference to FIG. 1.

First, the rough configuration of this device is such that a fuel stored in a fuel tank 1 is pressure-sent, via a high-pressure pump 2, to a common rail 4 to which a plurality of injection nozzles are connected, and operations of solenoid valves installed in the injection nozzles 3 are controlled by a control unit (denoted by ‘ECU’ in FIG. 1) 5, so that fuel injection from the injection nozzles 3 is controlled.

Hereinafter, the configuration of this device will be more specifically explained.

First, between the fuel tank 1 and a low-pressure side of the high-pressure pump 2, a filter 6 for removing dust and so on in the fuel and a low-pressure control solenoid valve 7 are disposed in this order from the fuel tank 1 side, and they are coupled to each other by a fuel pipe 8. Then, a fuel temperature sensor (hereinafter, referred to as a “fuel temp. sensor”) 9 is provided at an appropriate position in the fuel pipe 8 between the filter 6 and the low-pressure control solenoid valve 7, and an output signal thereof is inputted to the control unit 5, which will be described later. Further, a mechanical low-pressure control valve 10 is provided between an appropriate position, which is somewhere in the fuel pipe 8 between the filter 6 and the low-pressure control solenoid valve 7, and the fuel tank 1, and when receiving a predetermined valve opening pressure, it becomes in an open state so that the fuel between the low-pressure control solenoid valve 7 and the filter 6 is discharged to the fuel tank 1.

A high-pressure side of the high-pressure pump 2 is directly coupled to an inlet side of the common rail 4 by the fuel pipe 8.

An outlet side of the common rail 4 is connected to the fuel tank 1 by the fuel pipe 8 via a high-pressure control solenoid valve 11. Further, a high-pressure sensor 12 for detecting the common rail pressure is also disposed at an appropriate position of this common rail 4, and an output signal thereof is inputted to the control unit 5, which will be described next.

The control unit 5 is configured to execute, as will be described later, software to control the operations of the low-pressure control solenoid valve 7, the high-pressure control solenoid valve 11, and the not-shown solenoid valves in the injection nozzles 3, which are previously mentioned, and specifically, is constituted of, for example, a so-called microcontroller, various kinds of interface circuits, and so on.

The output signals of the fuel temp. sensor 9 and the high-pressure sensor 12 are inputted to this control unit 5 as described above, and besides, a rotation speed Ne of an engine (not shown), a depression amount Acc of an accelerator (not shown), position information Key of a so-called ignition engine key (not shown) for use in starting a vehicle are inputted thereto.

Note that, in this device, driving control of the low-pressure control solenoid valve 7 by the control unit 5 is so-called open control in which a driving current is simply outputted to the low-pressure control solenoid valve 7 from the control unit 5, but no feedback of a difference between the result thereof and a target driving state is given. On the other hand, driving control of the high-pressure control solenoid valve 11 by the control unit 5 is so-called feedback control in which the driving current by the control unit 5 to the high-pressure control solenoid valve 11 is adjusted based on the output signal of the high-pressure sensor 12 so as to make the common rail pressure equal to a desired pressure. Therefore, though this is for a case of so-called high-pressure control, in a case of so-called low-pressure control, the low-pressure control solenoid valve 7 is feedback-controlled, whereas the high-pressure control solenoid valve 11 is kept open.

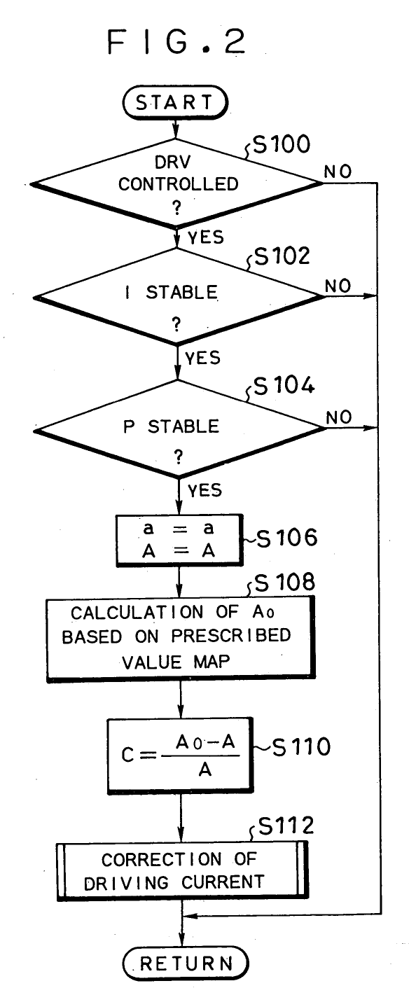

Next, a first operation control example executed in the configuration described above will be explained with reference to FIG. 2 to FIG. 5.

First, in this first operation control example, a preset control pattern, especially with respect to the operation control of the high-pressure control solenoid valve 11, is corrected based on data in an actual operation, and the operation of the high-pressure control solenoid valve 11 is controlled based on the corrected data. In other words, the driving current of the high-pressure control solenoid valve 11 is determined according to the common rail pressure in the common rail 4 based on a table, an arithmetic expression, or the like that defines the correlation between the common rail pressure and the driving current, which is preset in a predetermined memory area of the control unit 5, and the valve opening state (or valve closing state) is determined by this driving current, so that a desired common rail pressure is obtained. In this case, the correlation between the common rail pressure and the driving current of the high-pressure control solenoid valve 11 has been defined on the premise that the valve opening characteristic (or the valve closing characteristic) of the high-pressure control solenoid valve 11 for a driving current is constantly a certain presumed characteristic, but actually, the valve opening characteristic (or the valve closing characteristic) for the driving current often varies depending on individual high-pressure control solenoid valves 11. Further, the valve opening characteristic (or the valve closing characteristic) for a driving current of a single high-pressure control solenoid valve 11 sometimes differs from that when it is incorporated in the device actually used.

This first operation control example can realize operation control conforming to the actual operation in such a manner that the preset driving current of the high-pressure control solenoid valve 11 is corrected according to a desired common rail pressure based on the correlation between the driving current in the actual operation and the common rail pressure obtained by this driving current, and realizes so-called learning-based operation control.

Hereinafter, the procedure of this operation control will be specifically explained with reference to FIG. 2 to FIG. 5. First, a series of operation control procedure shown in FIG. 2 is executed as one subroutine process in a main routine process (not-shown) including other control processes executed by the control unit 5.

When this first operation control is started, it is first judged whether or not the high-pressure control solenoid valve 11 is in an operation state (refer to Step S100 in FIG. 2). Note that ‘DRV’ denotes the high-pressure control solenoid valve 11 in Step S100 in FIG. 2.

The reason why it is judged here whether or not the high-pressure control solenoid valve 11 is in a predetermined driving state is that the common-rail fuel injection device to which this operation control is applied has the low-pressure control solenoid valve 7 and the high-pressure control solenoid valve 11 as previously explained with reference to FIG. 1, and it is premised that this device is so configured to change the use thereof according to the operation state.

As criteria for judging whether or not the high-pressure control solenoid valve 11 is in the predetermined driving state, conceivable is, for example, the state in which the common rail pressure is set to a predetermined pressure or higher (for example, 1000 bar or higher) by driving the high-pressure control solenoid valve 11.

When it is judged in this Step S100 that the high-pressure control solenoid valve 11 is in the predetermined driving state (in a case of YES), the control proceeds to a process in Step S102 to be described next, whereas, when it is judged that the high-pressure control solenoid valve 11 is not in the predetermined driving state (in a case of NO), the current state is considered as not appropriate for the execution of a series of this operation control, in other words, a learning process, and the control returns to the not-shown main routine process.

In Step S102, it is judged whether or not the driving current outputted from the control unit 5 to the high-pressure control solenoid valve 11 is in a predetermined stable state. Here, it is suitable that the judgment on whether or not the driving current is in the predetermined stable state is made based on, for example, whether or not the driving current is in a predetermined fluctuation range (for example, within 10% of the driving current that is currently desired).

Then, when it is judged that the driving current is in the predetermined stable state (in a case of YES), the control proceeds to Step S104 to be described next, whereas, when it is judged that the driving current is not in the predetermined stable state (in a case of NO), the current state is considered as not appropriate for the execution of the learning process, similarly to the previous case of the process in Step S100, and the control returns to the not-shown main routine process.

In a process in Step S104, it is judged whether or not the common rail pressure is in a predetermined stable state. It is suitable here that the judgment on whether or not the common rail pressure is in the predetermined stable state is made based on, for example, whether or not the common rail pressure is within a predetermined fluctuation range (for example, within 10% of the common rail pressure desired at the current moment).

Then, when it is judged that the common rail pressure is in the predetermined stable state (in a case of YES), the control proceeds to a process in Step S106 to be described next, whereas, when it is judged that the common rail is not in the predetermined stable state (in a case of NO), the current state is considered as not appropriate for the execution of the learning process, similarly to the previous case of the process in Step S100, and the control returns to the not-shown main routine process.

In Step S106, a value a of the common rail pressure detected by the high pressure sensor 12 is substituted in a variable a, and at the same time, a driving current value A outputted from the control unit 5 to the high-pressure control solenoid valve 11 at that time is set as a variable A.

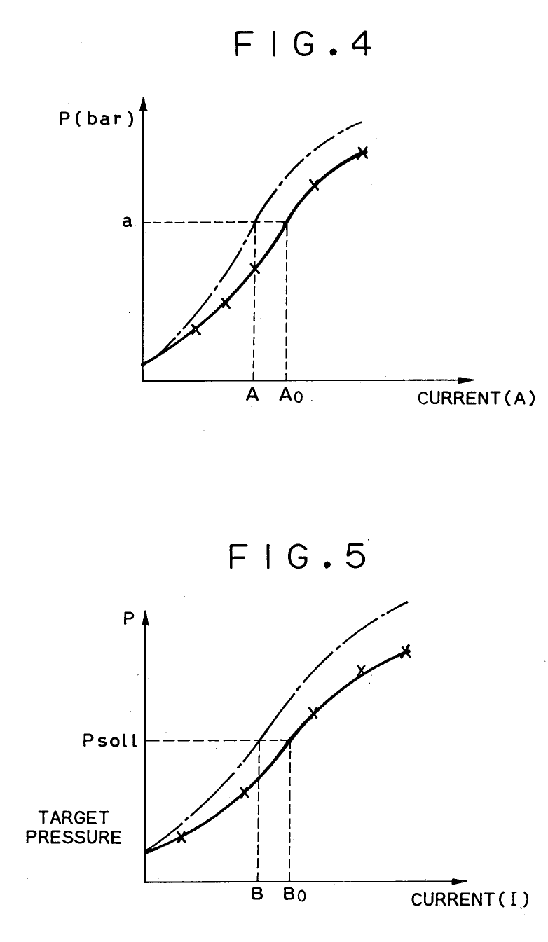

Next, the control proceeds to Step S108, where a driving current value A₀ of the high-pressure control solenoid valve 11 for the actual common rail pressure a at the current moment is derived based on a prescribed value map, which is stored in a not-shown memory area of the control unit 5 in advance, representing the correlation between the driving current of the high-pressure control solenoid valve 11 and the common rail pressure. Note that FIG. 4 shows an example of the prescribed value map. In this drawing, the characteristic line depicted with the solid line is the prescribed value map representing the correlation between the driving current and the common rail pressure, and the characteristic line depicted with the dashed line represents the correlation, which is assumed at the current moment, between the actually measured common rail pressure a and the driving current.

Next, the control proceeds to Step S110, where a ratio C of a difference between the driving current A₀ based on the prescribed value map and the actual driving current A to the actual driving current A (hereinafter, this C is referred to as a ‘correction coefficient’ for convenience' sake) is calculated.

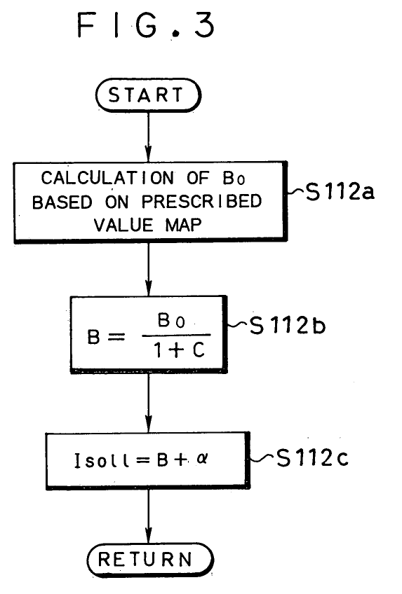

Next, a correction process of the driving current is executed (refer to Step S112 in FIG. 2). Specifically, in this correction process of the driving current, which is a subroutine process as shown in FIG. 3, a driving current B₀ of the high-pressure control solenoid valve 11 for a desired common rail pressure Pₛₒ₁₁ is first derived based on the aforesaid prescribed value map, where Pₛₒ₁₁ is the common rail pressure desired at the current moment (refer to Step S112a in FIG. 3 and FIG. 5).

Next, an actual driving current value B is derived using this obtained driving current B₀ and the correction coefficient C previously obtained (refer to Step S112b in FIG. 3). Specifically, the actual driving current value B is calculated as B=B₀/(1+C) (refer to FIG. 5).

Here, the derivation of B=B₀/(1+C) will be explained. First, (B₀−B)/B equals to the aforesaid correction coefficient C, where B is the driving current that is actually required for the desired common rail-pressure Pₛₒ₁₁. Therefore, C=(B₀−B)/B. Then, multiplying both sides of this equation by B gives C·B=B₀−B. Then, transposing B to the left side and calculating the equation can give B=B₀(1+C).

Next, the control proceeds to a process in Step S112c, where a conclusive actual driving current is determined. Specifically, a conclusive actual driving current Iₛₒ₁₁ in which the learning result is reflected is determined as Iₛₒ₁₁=B+α. Here, α is an allowance current for bringing the high-pressure control solenoid valve 11 into a completely closed state.

Then, after the driving current Iₛₒ₁₁ to be actually supplied to the high-pressure control solenoid valve 11 is calculated in the above-described manner, the control returns to the not-shown main routine process via the subroutine process shown in FIG. 2, and the aforesaid driving current Iₛₒ₁₁ is outputted to the high-pressure control solenoid valve 11 from the control unit 5 in the not-shown main routine process.

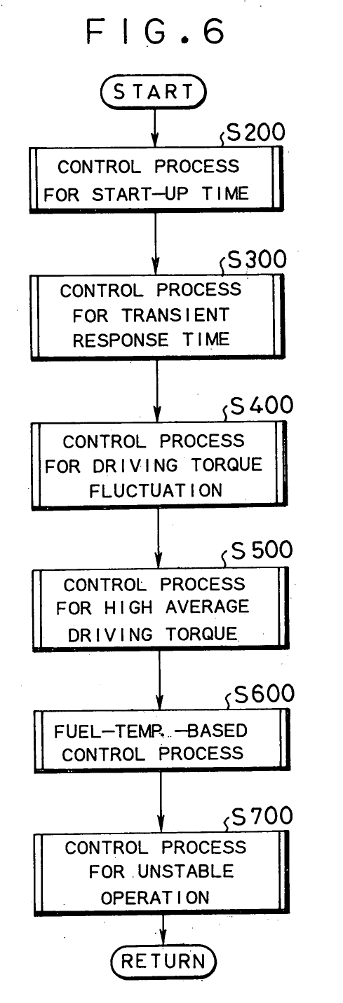

Next, a second operation control example will be explained with reference to FIG. 6 to FIG. 12.

This second operation control relates in particular to driving control of the low-pressure control solenoid valve 7 and the high-pressure control solenoid valve 11, and is so configured to change over the operation between the low-pressure control solenoid valve 7 and the high-pressure control solenoid valve 11 according to the operation state of the common-rail fuel injection device.

This second operation control is executed as one subroutine process in the main routine process (not shown) including other control processes executed by the control unit 5. FIG. 6 shows the overall procedure of this second operation control. Hereinafter, the contents thereof will be explained with reference to this drawing. In this second operation control, which consists of six subroutine processes as will be described next, a control process for start-up time is first executed (refer to Step S200 in FIG. 6). In this, it is judged whether or not an engine is at its start-up, and when the engine is at its start-up, the high-pressure control solenoid valve 11 is driven to control the common rail pressure (to be detailed later).

Next, a control process for transient response state is executed (refer to Step S300 in FIG. 6). In this, it is judged whether or not the operation state of the common-rail fuel injection device is a predetermined transient state, and when it is judged that it is the predetermined transient state, the high-pressure control solenoid valve 11 is driven, thereby controlling the common rail pressure (to be detailed later).

Next, a control process for driving torque fluctuation is executed (refer to Step S400 in FIG. 6). In this, when a driving torque of the high-pressure pump 2 fluctuates, the high-pressure control solenoid valve 11 is driven to control the common rail pressure (to be detailed later).

Next, a control process for high average driving torque is executed (refer to Step S500 in FIG. 6). In this, when an average driving torque of the high-pressure pump 2 is high, the low-pressure control solenoid valve 7 is driven to control the common rail pressure (to be detailed later).

Next, a fuel-temp.-based control process is executed (refer to Step S600 in FIG. 6). In this, the driving is changed over between the low-pressure control solenoid valve 7 and the high-pressure control solenoid valve 11 according to the fuel temperature to control the common rail pressure (to be detailed later).

Finally, a control process for unstable operation is executed (refer to Step S700 in FIG. 6), and after this process, the control returns to the not-shown main routine process. In this control process for unstable operation, in a predetermined unstable operation state, the high-pressure control solenoid valve 11 is driven to control the common rail pressure (to be detailed later).

Here, it is well known in the art that high-pressure (discharge) side control and low-pressure (intake) side control are available for controlling the common rail pressure, each having its own merit and demerit, and for reference for the operation controls to be explained below, the respective merits and demerits of the high-pressure (discharge) side control and the low-pressure (intake) side control will be briefly described.

First, the high-pressure (discharge) side control is a control method in which the high-pressure control solenoid valve 11 is driven, with an amount of oil to be fed to the common rail 4 from the high-pressure pump 2 being kept fixed, and unnecessary fuel is made to leak from the high-pressure side, thereby obtaining a desired value for the common rail pressure. A fuel injection amount from the injection nozzles 3, namely, an effective discharge amount in such high-pressure (discharge) side control is generally expressed as follows:

effective discharge amount=discharge amount of high pressure pump−volume removal amount from solenoid valve−(leak amount from injection nozzles and so on)

In the above equation, the volume removal amount from the solenoid valve means an amount of the fuel returned to the fuel tank 1 from the common rail 4 via the high-pressure control solenoid valve 11, namely, the leak amount. Examples of the merits on the side of the high-pressure pump 2 in such high-pressure (discharge) side control are good responsiveness in common rail pressure and a small fluctuation of a pump driving torque. On the other hand, examples of the demerits thereof are a high average pump driving torque, in other words, a large amount of wasteful work. The large amount of wasteful work indicates a large increase in fuel temperature.

Meanwhile, the low-pressure (intake) side control, which means that the low-pressure control solenoid valve 7 is driven so as to obtain only an amount of fed oil necessary for controlling the common rail pressure, is a control method in which an intake amount to the high-pressure pump 2 is controlled, thereby controlling the common rail pressure at a desired value. A fuel injection amount, namely, an effective discharge amount, from the injection nozzles 3 in such low pressure (intake) side control is typically expressed as follows:

effective discharge amount=discharge amount of high pressure pump−(leak amount from injection nozzles and so on)

An example of the merits on the high-pressure pump 2 side in such low-pressure (intake) side control is a low average pump driving torque, in other words, a small amount of wasteful work. This indicates, contrary to the case of the high-pressure (discharge) side control, a small increase in fuel temperature. On the other hand, one of the demerits is that responsiveness in the common rail pressure tends to be low, resulting in a large variation in driving torque (in other words, a large driving noise).

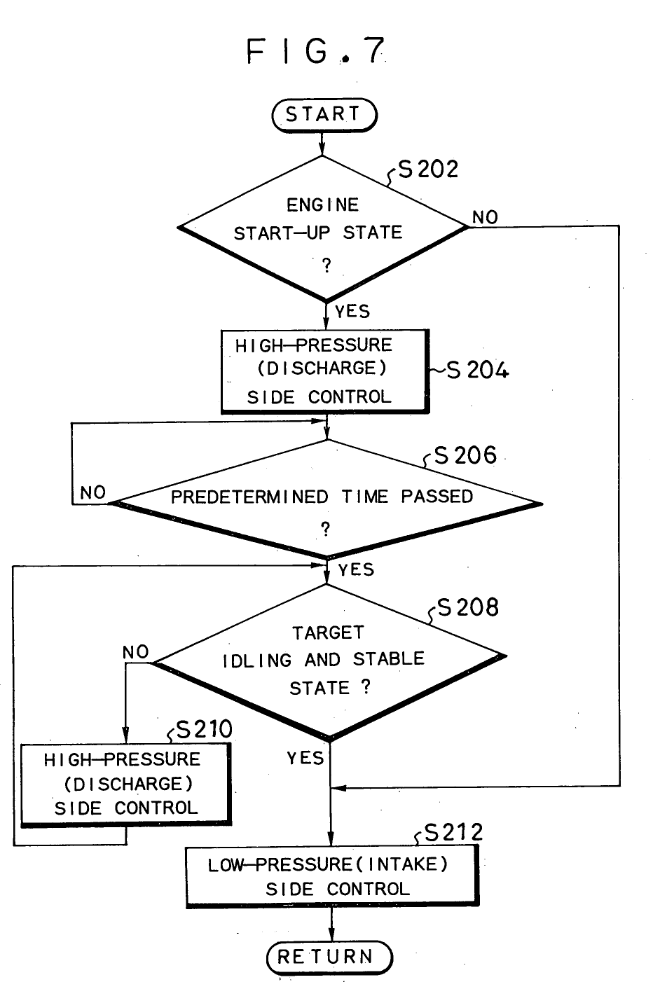

Next, the contents of each of the subroutine processes described above will be explained with reference to FIG. 7 to FIG. 12.

First, the control process for start-up time will be explained with reference to FIG. 7. When the operation control is started, it is judged whether or not the engine is in a start-up state (refer to Step S202 in FIG. 7). The judgment on whether or not the engine is in the start-up state is preferably made based on an engine rotation speed Ne, position information of an ignition engine key (not shown), and the common rail pressure that are inputted to the control unit 5.

Then, when it is judged that the engine is in the start-up state (in a case of YES), the control proceeds to a process in Step S204 to be described next, whereas, when it is judged that the engine is not in the start-up state (in a case of NO), the control proceeds to a process in Step S212 to be described later (refer to Step S202 in FIG. 7).

In Step S204, the high-pressure (discharge) side control is executed in response to that the engine is in the start-up state. Specifically, when the engine is in the start-up state, the execution of highly responsive control is desired as the control of the common rail pressure during a period from the initial explosion of the engine at least until it becomes stable in an idling state, and therefore, the high-pressure (discharge) side control is suitable, and accordingly, the control unit 5 controls the high-pressure control solenoid valve 11 to be driven so as to set a necessary common rail pressure.

Next, it is judged whether or not a predetermined period of time has passed from the engine start-up (refer to Step S206 in FIG. 7), and when it is judged that the predetermined period of time has passed, it is judged whether or not the common rail pressure has reached a target idling and stable state (refer to Step S208 in FIG. 7).

Here, the target idling and stable state means the state of the common rail pressure when the not-shown engine is in an idling state and substantially in a stable state. The judgment on whether or not the engine is in the target idling and stable state is suitably made based on whether or not the engine rotation speed Ne inputted to the control unit 5 and the common rail pressure detected by the high-pressure sensor 12 and inputted to the control unit 5 are within predetermined ranges respectively.

In Step S208, when it is judged that the common rail pressure is in the target idling and stable state (in a case of YES), the control proceeds to a process in Step S212 to be described next. On the other hand, when it is judged in Step S208 that the common rail pressure is not in the target idling and stable state (in a case of NO), the high-pressure (discharge) side control is continued until it is judged that the common rail pressure is in the target idling and stable state (refer to Steps S210 and S208 in FIG. 7).

After it is judged in Step S202 that the engine is not in the start-up state (in a case of NO), or after it is judged in Step S208 that the common rail pressure has reached the target idling and stable state (in a case of YES), the required responsiveness of the common rail pressure is not very high, and therefore, the high-pressure (discharge) side control that has been executed up to the current moment is changed to the low-pressure (intake) side control, in which the low-pressure control solenoid valve 7 in place of the high-pressure control solenoid valve 11 is controlled to be driven to adjust the common rail pressure (refer to Step S212 in FIG. 7). Then, thereafter, the control tentatively returns to the aforesaid routine shown in FIG. 6.

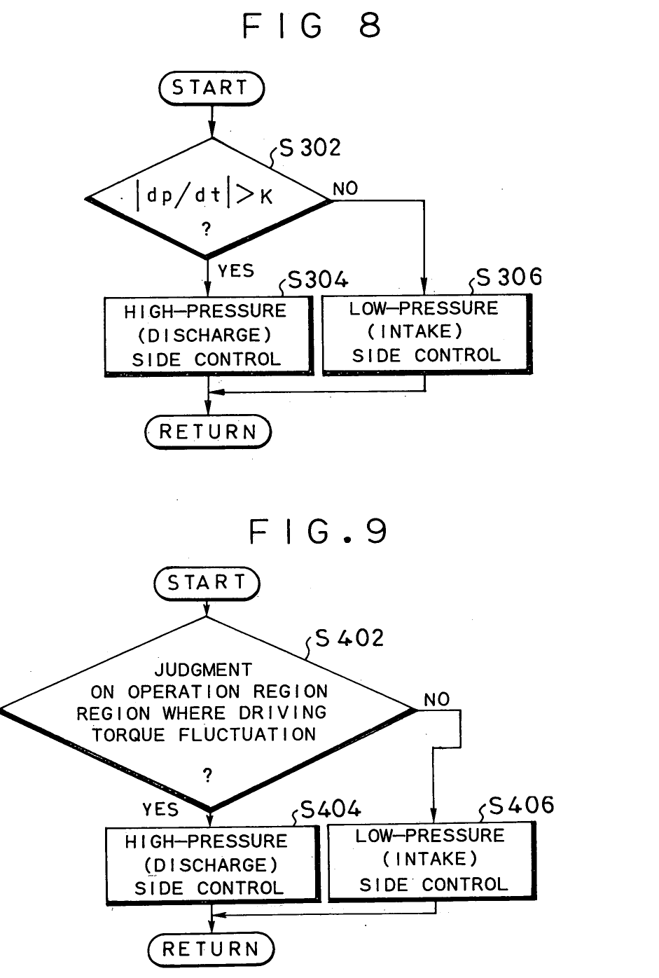

Next, the control process for transient response state will be explained with reference to FIG. 8.

When the operation control is started, it is first judged whether or not the operation of this device is in a transient response state (refer to Step S302 in FIG. 8).

Specifically, first, the transient response state here means the case when the common rail pressure needs to be reduced or increased by a predetermined value or more. This state occurs, for example, when a drastic change occurs in an accelerator depression amount, and so on.

The judgment on the transient response state or not is suitably made, for example, based on whether or not an absolute value of a variation amount dP/dt of the common rail pressure per unit time exceeds a predetermined value K. This predetermined value K is suitably determined in consideration of, for example, fuel temperature, the temperature of an engine cooling water, and so on, and though one value may be selected based on experimental values, empirical data, and so on thereof, it is also suitable that several values are selectively used according to the fuel temperature and the temperature of the engine cooling water.

When it is judged in this Step S302 based on the aforesaid judging criteria that the operation of this device is in the predetermined transient response state (in a case of YES), the low-pressure (intake) side control cannot follow the variation in the common rail pressure as required, and accordingly, the high-pressure (discharge) side control is executed (refer to Step S304 in FIG. 8). On the other hand, when it is judged in Step S302 that the operation of this device is not in the predetermined transient response state (in a case of NO), the low-pressure (intake) side control is maintained (refer to Step S306 in FIG. 8). Then, after either one of Steps S304 and S306 is executed, the control tentatively returns to the aforesaid routine shown in FIG. 6.

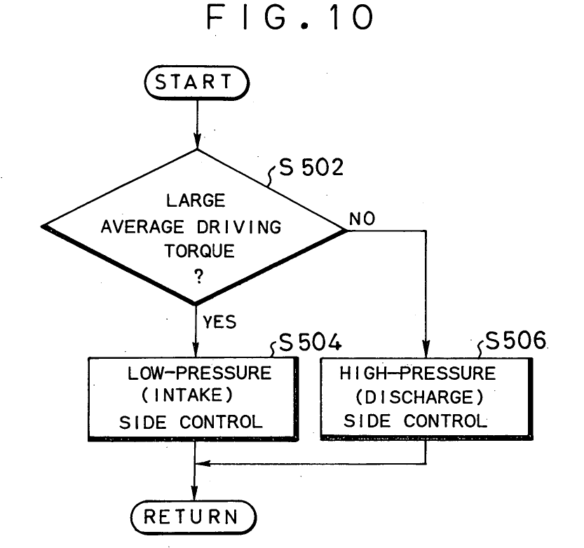

Next, the control process for driving torque fluctuation will be explained with reference to FIG. 9.

When the operation control is started, it is first judged whether or not the operation state of this device is in an operation state in which a driving torque fluctuation is problematic (refer to Step S402 in FIG. 9).

Specifically, first, “the driving torque fluctuation is problematic” here means that a fluctuation of the driving torque occurs due to some reason in the low-pressure (intake) side control state, and a so-called driving noise may occur if the low-pressure (intake) side control is kept continued, so that it becomes impossible to obtain a stable common rail pressure. One of the factors causing the driving torque fluctuation is, for example, an intermittent oil feeding in the low-pressure (intake): side control. This means the case when a necessary fuel is intermittently fed to the common rail 4 from the high-pressure pump 2.

The judgment on the operation state or not in which the driving torque fluctuation is problematic is suitably made, for example, based on comparison and consideration of the engine rotation speed Ne, the common rail pressure, an oil feeding amount of the high-pressure pump 2, and so on. More specifically, it is suitable that the judgment that the operation state in which the driving torque fluctuation is problematic exists is made, for example, when a variation amount of the engine rotation speed Ne, a variation amount of the common rail pressure, and a variation amount of the oil feeding amount of the high-pressure pump 2 exceed predetermined variation amounts respectively, and numerical ranges being criteria for the respective judgments are suitably set based on experiments or simulation by a computer, or further based on empirical data or the like.

Then, when it is judged in this Step S402 that this device is in the operation state in which the driving torque fluctuation is problematic (in a case of YES), the high-pressure (discharge) side control is executed (refer to Step S404 in FIG. 9). On the other hand, when it is judged that this device is not in the operation state in which the driving torque fluctuation is problematic (in a case of NO), the low-pressure (intake) side control is maintained (refer to Step S406 in FIG. 9). Then, after either one of Steps S404 and S406 is executed, the control tentatively returns to the aforesaid routine shown in FIG. 6.

Next, the control process for high average driving torque will be explained with reference to FIG. 10.

When the operation control is started, it is first judged whether or not this device is in the operation state with a high average driving torque (refer to Step S502 in FIG. 10).

Specifically, first, the operation state with the high average driving torque means the state in which an amount of wasteful work is large in the state of the high-pressure (discharge) side control. The judgment on the operation state with the high average driving torque or not may be made in such a manner that an average driving torque at the current moment is derived through an arithmetic operation and it is judged whether or not the derived result exceeds a predetermined value, or alternatively, in such a manner that the increase in fuel temperature is equal to a predetermined value or higher.

Then, when it is judged in this Step S502 that this device is in the operation-state with the high average driving torque (in a case of YES), the high-pressure (discharge) side control is changed to the low-pressure (intake) side control, so that the low-pressure (intake) side control is executed (refer to Step S504 in FIG. 10). On the other hand, when it is judged that this device is not in the operation state with the high average driving torque (in a case of NO), the high-pressure (discharge) side control is maintained (refer to Step S506 in FIG. 10). Then, after either one of Steps S504 and S506 is executed, the control tentatively returns to the aforesaid routine shown in FIG. 6.

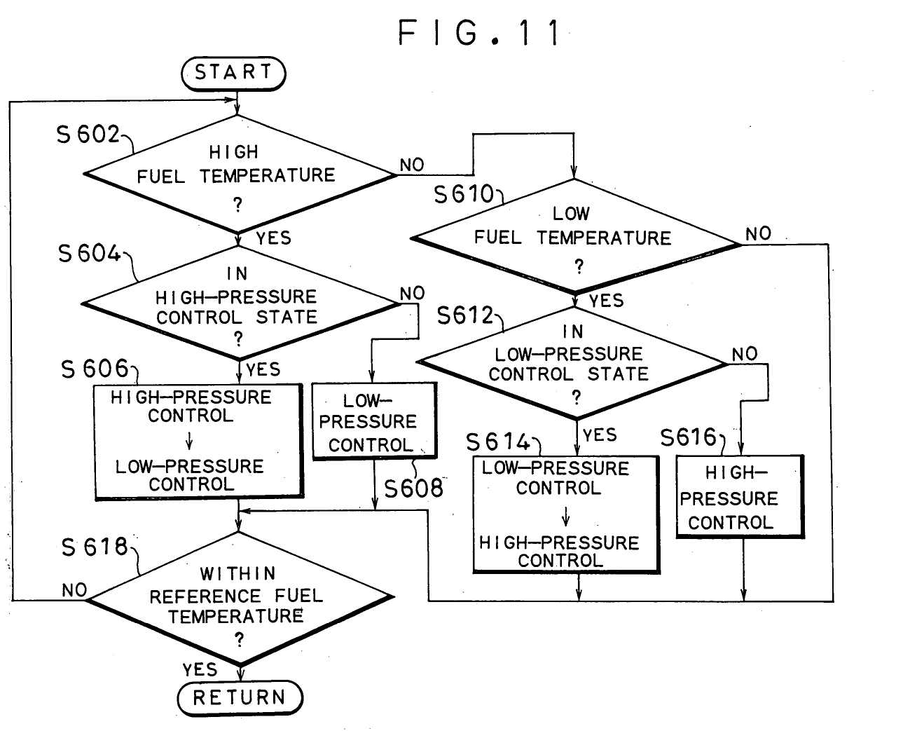

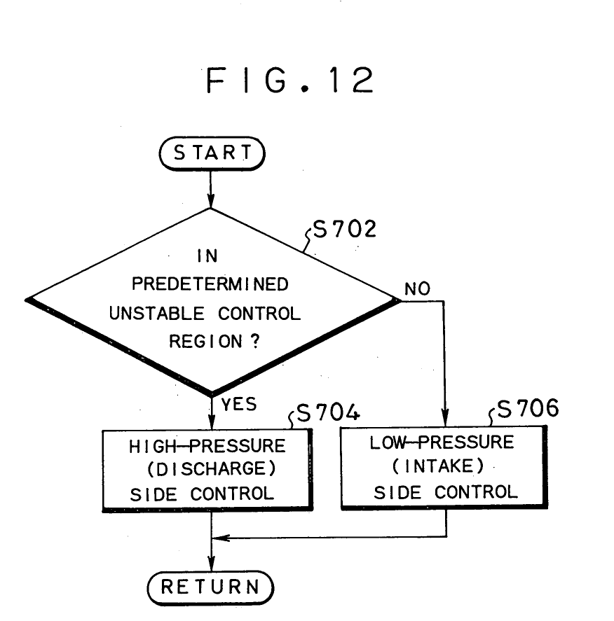

Next, the fuel-temp.-based control process will be explained with reference to FIG. 11.

When the operation control is started, it is first judged whether or not a fuel temperature (fuel temp.) is in a high state in which it exceeds a predetermined high temperature reference value (refer to Step S602 in FIG. 11). Then, the judgment that the fuel temperature exceeds the predetermined high temperature reference value, in other words, it is in the high state (in a case of YES) indicates the state in which wasteful work exists in the operation of the high-pressure pump 2, and since this state requires the execution of the low-pressure (intake) side control for the purpose of decreasing the fuel temperature, it is first judged whether or not this device is in the high-pressure (discharge) side control state (refer to Step S604 in FIG. 11).

When it is judged in Step S604 that this device is in the high-pressure (discharge) side control state (in a case of YES), the high-pressure (discharge) side control is changed to the low-pressure (intake) side control, so that the low-pressure (intake) side control is executed (refer to Step S606 in FIG. 11).

On the other hand, when it is judged in Step S604 that this device is not in the high-pressure (discharge) side control state (in a case of NO), the low-pressure (intake) side control is maintained (refer to Step S608 in FIG. 11).

On the other hand, when it is judged in the previous Step S602 that the fuel temperature is not in the high state in which the fuel temperature exceeds the predetermined high temperature reference value (in a case of NO), it is judged whether or not the fuel temperature is in a low state in which it is lower than a predetermined low temperature reference value (refer to Step S610 in FIG. 11). Then, when it is judged that the fuel temperature is lower than the predetermined low temperature reference value, in other words, it is in the low state (in a case of YES), it is necessary to execute the high-pressure (discharge) side control for the purpose of increasing the fuel temperature, and therefore, it is first judged whether or not the current state is the low-pressure (intake) side control state (refer to Step S612 in FIG. 11).

When it is judged in Step S612 that the current state is the low-pressure (intake) side control state (in a case of YES), the low-pressure (intake) side control is changed to the high-pressure (discharge) side control, so that the high-pressure (discharge) side control is executed (refer to Step S614 in FIG. 11). On the other hand, when it is judged in Step S612 that the current state is not the low-pressure (intake) side control state (in a case of NO), the high-pressure (discharge) side control is maintained (refer to Step S616 in FIG. 11).

Then, after any one of Steps S606, S608, S614, and S616 is executed, it is judged whether or not the fuel temperature is within a predetermined reference range (refer to Step S618 in FIG. 11), and, when it is judged that the fuel temperature is not within the predetermined reference range (in a case of NO), the control returns to the previous Step S602 and a series of the processes is repeated, whereas, when it is judged that the fuel temperature is within the predetermined reference range (in a case of YES), the control tentatively returns to the aforesaid routine shown in FIG. 6.

Next, the control process for unstable operation will be explained with reference to FIG. 12.

When the operation control is started, it is first judged whether or not the operation of this device, in other words, the state of the fuel injection control is in a predetermined unstable operation region (refer to Step S702 in FIG. 12).

Here, the case when the judgment indicating the predetermined unstable operation region is made corresponds to a case, first on the premise that the current state is in the low-pressure (intake) side control state, where it is concerned that mechanical vibration may occur in a mechanical valve in this device due to the fact that a controlled amount of the injected fuel is injected at a smaller flow rate compared with that in the case of the high-pressure (discharge) side control, or where there is a possibility that a cavity may occur due to intake restriction on the high-pressure pump 2, and accordingly, it is concerned that reliability of the operation of this device may possibly lower.

More specific judgment criteria are a controlled flow rate of the fuel in the former case, and an amount of intake restriction in the latter case, but specific appropriate values thereof depend on the actual scale, operation conditions, and so on of the device, and therefore, they should be set in consideration of these factors.

Then, when it is judged in Step S702 based on the aforesaid judgment criteria that the operation of this device is in the predetermined unstable operation region (in a case of YES), the high-pressure (discharge) side control is executed in place of the low-pressure (intake) side control (refer to Step S704 in FIG. 12), whereas, when it is judged that the operation of this device is not in the predetermined unstable operation region (in a case of NO), the low-pressure (intake) side control is maintained (refer to Step S706 in FIG. 12). Then, after either one of Steps S704 and S706 is executed, the control tentatively returns to the aforesaid routine shown in FIG. 6.

In the configuration example described above, roughly six kinds of the controls, starting from the control process for start-up time (refer to Step S200 in FIG. 6) up to the control process for unstable operation (refer to Step S700 in FIG. 6), are executed as the controls in which the driving is changed over between the low-pressure control solenoid valve 7 and the high-pressure control solenoid valve 11, as shown in FIG. 6, but it is not always necessary to execute all of them, and such a configuration may of course be adopted that, for example, only any one of the six kinds of the controls is executed, in consideration of the actual scale, required performance, and so on of the device. In addition, such a configuration that an arbitrary number of controls among the aforesaid six kinds of the controls may be combined.

Further, in the configuration example described above, the low-pressure control solenoid valve 7 is disposed at an appropriate position in the fuel pipe 8 connecting the fuel tank 1 and the high-pressure pump 2 as an example of disposing the low-pressure control solenoid valve 7 therebetween, but the configuration is not of course limited to this, and it may be disposed in the high-pressure pump 2. Moreover, though the high-pressure control solenoid valve 11 is disposed at an appropriate position in the fuel pipe 8 between the common rail 4 and the fuel tank 1, the high-pressure control solenoid valve 11 may of course be disposed on a discharge side of the high-pressure pump 2. In other words, the high-pressure control solenoid valve 11 may be disposed at an appropriate position in an area from the high-pressure pump 2 up to the injection nozzles 3.

As described hitherto, according to the present invention, such a configuration is adopted that the driving current to the high-pressure control solenoid valve that is determined by the prescribed value map is corrected according to an actual driving state under predetermined conditions, which brings about such an effect that appropriate and reliable fuel injection can be realized, responding to a variation in operational characteristic of high-pressure control solenoid valves and a difference in operation conditions among individual devices.

Further, according to the present invention, such a configuration is adopted that the control is changed over between the high pressure side control and the low pressure side control in accordance with various operation states of the device, which brings about such an effect that the responsiveness in the common rail pressure is improved, so that control stability is improved, and stable and reliable fuel injection can be realized. In addition, with the configuration that the high-pressure side control and the low-pressure side control are provided, even when one of them is in fault, the other control can cope with the situation, which brings about such an effect that safety and reliability of the device against fault can be improved. Further, with such a configuration that the control is changed over between the high-pressure side control and the low-pressure side control, compared with such a configuration that only the high-pressure side control is executed, the load of the high-pressure pump can be reduced by also executing the low-pressure side control, which brings about such an effect that reliability of the high-pressure pump can be improved.

As described hitherto, a fuel injection device according to the present invention is a device that injects and supplies a fuel to an internal combustion machine such as an engine for vehicles, and is particularly suitable for those with the configuration of a so-called common-rail type.

What is claimed is:

1. An operation control method in a fuel injection device comprising: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,
the method being so configured that, when a pressure in the common rail exceeds a predetermined value in a state in which the high-pressure control solenoid valve is driven to control the pressure in the common rail, a driving current determined by a prescribed value map defining a correlation between the pressure in the common rail and the driving current of the high-pressure control solenoid valve is corrected based on an actual pressure in the common rail and a driving current of the high-pressure control solenoid valve at the actual pressure, and the corrected driving current is passed to the high-pressure control solenoid valve.

2. An operation control method in a fuel injection device comprising: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,
the method being so configured that, when an engine is in a predetermined start-up state, the high-pressure control solenoid valve is controlled to be driven until a predetermined period of time passes after the engine is activated, thereby controlling a pressure in the common rail.

3. An operation control method in a fuel injection device comprising: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,
the method being so configured that, when an absolute value of a variation amount of a pressure in the common rail exceeds a predetermined value, the high-pressure control solenoid valve is controlled to be driven, thereby controlling the pressure in the common rail.

4. An operation control method in a fuel injection device comprising: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,
the method being so configured that, when a fluctuation of a driving torque of the high-pressure pump exceeds a predetermined state, the high-pressure control solenoid valve is controlled to be driven, thereby controlling a pressure in the common rail.

5. An operation control method in a fuel injection device comprising: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,
the method being so configured that, when an average driving torque of the high-pressure pump exceeds a predetermined state, the low-pressure control solenoid valve is controlled to be driven, thereby controlling a pressure in the common rail.

6. An operation control method in a fuel injection device comprising: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,
the method being so configured that, when a fuel temperature is in a predetermined high-temperature state and the high-pressure control solenoid valve is being driven, the low-pressure control solenoid valve is controlled to be driven in place of driving the high-pressure control solenoid valve, until the fuel temperature falls within a predetermined reference temperature range, thereby controlling a pressure in the common rail, whereas,
when the fuel temperature is in a predetermined low-temperature state and the low-pressure control solenoid valve is being driven, the high-pressure control solenoid valve is controlled to be driven in place of driving the low-pressure control solenoid valve, until the fuel temperature falls within the predetermined reference temperature range, thereby controlling the pressure in the common rail.

7. An operation control method in a fuel injection device comprising: a high-pressure pump that pressure-sends a fuel in a fuel tank; a common rail in which the fuel pressure-sent by the high-pressure pump is temporarily stored; a plurality of injection nozzles attached to the common rail, each having a solenoid valve; a low-pressure control solenoid valve provided between the fuel tank and the high-pressure pump; a high-pressure control solenoid valve provided in an area from the high-pressure pump up to the injection nozzles; and a control unit that controls operations of the high-pressure pump, the respective solenoid valves of the plural injection nozzles, the low-pressure control solenoid valve, and the high-pressure control solenoid valve,
the method being so configured that, when the fuel injection device is in a predetermined unstable operation state, the high-pressure control solenoid valve is controlled to be driven, thereby controlling a pressure in the common rail.

8. A fuel injection device comprising: a high-pressure pump that pressure-sends a fuel in a fuel tank; a common rail in which the fuel pressure-sent by said high-pressure pump is temporarily stored; a plurality of injection nozzles attached to said common rail, each having a solenoid valve; a low-pressure control solenoid valve provided between said fuel tank and said high-pressure pump; a high-pressure control solenoid valve provided in an area from said high-pressure pump up to said injection nozzles; and a control unit that controls operations of said high-pressure pump, the respective solenoid valves of said plural injection nozzles, said low-pressure control solenoid valve, and said high-pressure control solenoid valve,
wherein said control unit is so configured to control said low-pressure control solenoid valve and said high-pressure control solenoid valve to be selectively driven based on a temperature of the fuel, a pressure in said common rail, an engine rotation speed, an accelerator depression amount, and position information of an ignition engine key that are inputted from an external part, and has a prescribed value map stored therein that defines correlation between the pressure in said common rail and a driving current of said high-pressure control solenoid valve, and
in controlling said high-pressure control solenoid valve to be driven,
said control unit determines the driving current of said high-pressure control solenoid valve for a desired pressure in said common rail based on the prescribed value map and passes the determined driving current to said high-pressure control solenoid valve until the pressure in said common rail is judged to exceed a predetermined variation amount, whereas,
when the pressure in said common rail is judged to exceed a predetermined value, said control unit corrects the driving current determined by the prescribed value map based on an actual pressure in said common rail and the driving current of said high-pressure control solenoid value at the actual pressure, and passes the corrected driving current to said high-pressure control solenoid value.

9. A fuel injection device comprising: a high-pressure pump that pressure-sends a fuel in a fuel tank; a common rail in which the fuel pressure-sent by said high-pressure pump is temporarily stored; a plurality of injection nozzles attached to said common rail, each having a solenoid valve; a low-pressure control solenoid valve provided between said fuel tank and said high-pressure pump; a high-pressure control solenoid valve provided in an area from said high-pressure pump up to said injection nozzles; and a control unit that controls operations of said high-pressure pump, the respective solenoid valves of said plural injection nozzles, said low-pressure control solenoid valve, and said high-pressure control solenoid valve,
wherein said control unit is so configured to control said low-pressure control solenoid valve and said high-pressure control solenoid valve to be selectively driven based on a temperature of the fuel, a pressure in said common rail, an engine rotation speed, an accelerator depression amount, and position information of an ignition engine key that are inputted from an external part, and
as a result of judgment on whether or not an engine is in a predetermined start-up state,
when the engine is judged to be in the predetermined start-up state, said control unit controls said high-pressure control solenoid valve to be driven until a predetermined period of time passes after the engine is activated, whereas,
when the engine is judged not to be in the predetermined start-up state, said control unit drives said low-pressure control solenoid valve.

10. A fuel injection device comprising: a high-pressure pump that pressure-sends a fuel in a fuel tank; a common rail in which the fuel pressure-sent by said high-pressure pump is temporarily stored; a plurality of injection nozzles attached to said common rail, each having a solenoid valve; a low-pressure control solenoid valve provided between said fuel tank and said high-pressure pump; a high-pressure control solenoid valve provided in an area from said high-pressure pump up to said injection nozzles; and a control unit that controls operations of said high-pressure pump, the respective solenoid valves of said plural injection nozzles, said low-pressure control solenoid valve, and said high-pressure control solenoid valve,
wherein said control unit is so configured to control said low-pressure control solenoid valve and said high-pressure control solenoid valve to be selectively driven based on a temperature of the fuel, a pressure in said common rail, an engine rotation speed, an accelerator depression amount, and position information of an ignition engine key that are inputted from an external part, and
as a result of judgment on whether or not an absolute value of a variation amount of the pressure in said common rail exceeds a predetermined value,
when the absolute value of the variation amount of the pressure in said common rail is judged to exceed the predetermined value, said control unit controls said high-pressure control solenoid valve to be driven, whereas,
when the absolute value of the variation amount of the pressure in said common rail is judged not to exceed the predetermined value, said control unit controls said low-pressure control solenoid valve to be driven.

11. A fuel injection device comprising: a high-pressure pump that pressure-sends a fuel in a fuel tank; a common rail in which the fuel pressure-sent by said high-pressure pump is temporarily stored; a plurality of injection nozzles attached to said common rail, each having a solenoid valve; a low-pressure control solenoid valve provided between said fuel tank and said high-pressure pump; a high-pressure control solenoid valve provided in an area from said high-pressure pump up to said injection nozzles; and a control unit that controls operations of said high-pressure pump, the respective solenoid valves of said plural injection nozzles, said low-pressure control solenoid valve, and said high-pressure control solenoid valve,
wherein said control unit is so configured to control said low-pressure control solenoid valve and said high-pressure control solenoid valve to be selectively driven based on a temperature of the fuel, a pressure in said common rail, an engine rotation speed, an accelerator depression amount, and position information of an ignition engine key that are inputted from an external part, and
as a result of judgment on whether or not a fluctuation of a driving torque of said high-pressure pump exceeds a predetermined state,
when the fluctuation of the driving torque of said high-pressure pump is judged to exceed the predetermined state, said control unit controls said high-pressure control solenoid valve to be driven, whereas,
when the fluctuation of the driving torque of said high-pressure pump is judged not to exceed the predetermined state, said control unit controls said low-pressure control solenoid valve to be driven.

12. A fuel injection device comprising: a high-pressure pump that pressure-sends a fuel in a fuel tank; a common rail in which the fuel pressure-sent by said high-pressure pump is temporarily stored; a plurality of injection nozzles attached to said common rail, each having a solenoid valve; a low-pressure control solenoid valve provided between said fuel tank and said high-pressure pump; a high-pressure control solenoid valve provided in an area from said high-pressure pump up to said injection nozzles; and a control unit that controls operations of said high-pressure pump, the respective solenoid valves of said plural injection nozzles, said low-pressure control solenoid valve, and said high-pressure control solenoid valve,
wherein said control unit is so configured to control said low-pressure control solenoid valve and said high-pressure control solenoid valve to be selectively driven based on a temperature of the fuel, a pressure in said common rail, an engine rotation speed, an accelerator depression amount, and position information of an ignition engine key that are inputted from an external part, and
as a result of judgment on whether or not an average driving torque of said high-pressure pump exceeds a predetermined state,
when the average driving torque of said high-pressure pump is judged to exceed the predetermined state, said control unit controls said low-pressure control solenoid valve to be driven, whereas,
when the average driving torque of said high-pressure pump is judged not to exceed the predetermined state, said control unit controls said high-pressure control solenoid valve to be driven.

13. A fuel injection device comprising: a high-pressure pump that pressure-sends a fuel in a fuel tank; a common rail in which the fuel pressure-sent by said high-pressure pump is temporarily stored; a plurality of injection nozzles attached to said common rail, each having a solenoid valve; a low-pressure control solenoid valve provided between said fuel tank and said high-pressure pump; a high-pressure control solenoid valve provided in an area from said high-pressure pump up to said injection nozzles; and a control unit that controls operations of said high-pressure pump, the respective solenoid valves of said plural injection nozzles, said low-pressure control solenoid valve, and said high-pressure control solenoid valve,
wherein said control unit is so configured to control said low-pressure control solenoid valve and said high-pressure control solenoid valve to be selectively driven based on a temperature of the fuel, a pressure in said common rail, an engine rotation speed, an accelerator depression amount, and position information of an ignition engine key that are inputted from an external part, and
as a result of judgment on whether or not a temperature of the fuel is in a predetermined high temperature state,
when the temperature of the fuel is judged to be in the predetermined high temperature state, said control unit judges whether or not said high-pressure control solenoid valve is being driven, and when said high-pressure control solenoid valve is judged to be in the driven state, said control unit controls said low-pressure control solenoid valve to be driven in place of driving said high-pressure control solenoid valve, until the temperature of the fuel falls within a predetermined reference temperature range, while, when said high-pressure control solenoid valve is judged not to be in the driven state, said control unit controls said low-pressure control solenoid valve to be driven until the temperature of the fuel falls within the predetermined reference temperature range, whereas,
when the temperature of the fuel is judged not to be in the predetermined high temperature state, said control unit judges whether or not the temperature of the fuel is in a predetermined low temperature state, and when the temperature of the fuel is judged to be in the predetermined low temperature state, said control unit judges whether or not said low-pressure control solenoid valve is being driven, and when the low-pressure control solenoid valve is judged to be in the driven state, said control unit controls said high-pressure control solenoid valve to be driven in place of driving said low-pressure control solenoid valve until the temperature of the fuel falls within the predetermined reference temperature range, while, when said low-pressure control solenoid valve is judged not to be in the driven state, said control unit controls said high-pressure control solenoid valve to be driven until the temperature of the fuel falls within the predetermined reference temperature range.

14. A fuel injection device comprising: a high-pressure pump that pressure-sends a fuel in a fuel tank; a common rail in which the fuel pressure-sent by said high-pressure pump is temporarily stored; a plurality of injection nozzles attached to said common rail, each having a solenoid valve; a low-pressure control solenoid valve provided between said fuel tank and said high-pressure pump; a high-pressure control solenoid valve provided in an area from said high-pressure pump up to said injection nozzles; and a control unit that controls operations of said high-pressure pump, the respective solenoid valves of said plural injection nozzles, said low-pressure control solenoid valve, and said high-pressure control solenoid valve,
wherein said control unit is so configured to control said low-pressure control solenoid valve and said high-pressure control solenoid valve to be selectively driven based on a temperature of the fuel, a pressure in said common rail, an engine rotation speed, an accelerator depression amount, and position information of an ignition engine key that are inputted from an external part, and
as a result of judgment on whether or not a state of fuel injection control is a predetermined unstable operation state,
when the state of the fuel injection control is judged to be the predetermined unstable operation state, said control unit controls said high-pressure control solenoid valve to be driven, whereas,
when the state of the fuel injection control is judged not to be the predetermined unstable operation state, said control unit controls said low-pressure control solenoid valve to be driven.
